(19) United States
(12) Patent Application Publication
(10) Pub. No.: US 2006/0007308 A1
(43) Pub. Date: Jan. 12, 2006

(54) ENVIRONMENTALLY AWARE, INTELLIGENT SURVEILLANCE DEVICE

(76) Inventors: Curtis Evan Ide, Roswell, GA (US); John Jackson, Atlanta, GA (US); Glenn Matthew McGonnigle, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/905,719

(22) Filed: Jan. 18, 2005

Related U.S. Application Data
(63) Continuation-in-part of application No. 10/889,224, filed on Jul. 12, 2004, now abandoned.

(51) Int. Cl. H04N 7/18; H04N 9/47

(52) U.S. Cl. 348/143

(57) ABSTRACT

The present invention relates to methods and systems for the remote monitoring and sensing of a remote deployable, stand-alone, environmentally aware surveillance sensor device or unit that is capable of self-determining its location and orientation relative to a real world, 3D environment, detect conditions or events within the sensor's range of detection within that environment, and provide event information indicative of detected conditions or events including their location relative to the 3D real world environment as well as the raw sensor data feed to an external utilization system such as a security monitoring system. The exemplary sensor unit obtains position information from a position information source, orientation information from an orientation information source and time information, thereafter the unit processes the sensor feed to detect objects and types of objects, and provides event information or information output to an external utilization system such as a security monitoring system.

This application is a continuation-in-part of U.S. patent application entitled “Environmentally Aware, Intelligent Surveillance Device,” filed Jul. 12, 2004, and assigned Ser. No. 10/889,224, the disclosure of which is incorporated herein by reference in its entirety.

This application also claims the benefit, pursuant to 35 U.S.C. §119(e), of U.S. Provisional Patent Application entitled “ENVIRONMENTALLY AWARE, INTELLIGENT SURVEILLANCE DEVICE,” filed on Jul. 11, 2003, and assigned Ser. No. 60/486,766, the disclosure of which is incorporated herein by reference in its entirety.

The applicant expressly reserves the right to claim priority to U.S. patent application Ser. No. 10/676,395 filed Oct. 1, 2003, entitled “SYSTEM AND METHOD FOR INTERPOLATING COORDINATE VALUE BASED UPON CORRELATION BETWEEN 2D ENVIRONMENT AND 3D ENVIRONMENT,” the disclosure of which is incorporated herein by reference in its entirety.

### CROSS-REFERENCE TO RELATED APPLICATIONS

This application is related to co-pending U.S. patent application Ser. No. 10/236,720 entitled “Sensor Device for use in Surveillance System” filed on Sep. 2, 2002; co-pending U.S. patent application Ser. No. 10/236,81 9 entitled “Security Data Management System” filed on Sep. 6, 2002; co-pending U.S. patent application Ser. No. 10/237,202 entitled “Surveillance System Control Unit” filed on Sep. 6, 2002; and co-pending U.S. patent application Ser. No. 10/237,203 entitled “Surveillance System Data Center” filed on Sep. 6, 2002, the disclosures of which are all entirely incorporated herein by reference.

### TECHNICAL FIELD

The present invention is generally related to remote monitoring and sensing, and is more particularly related to a remote deployable, stand-alone, environmentally aware surveillance sensor device that is capable of self-determining its location and orientation relative to a real world, three-dimensional (3D) environment, detect conditions or events within the sensor's range of detection within that environment, and provide event information indicative of detected conditions or events including their location relative to the 3D real world environment as well as the raw sensor data feed, to an external utilization system such as a security monitoring system.

### BACKGROUND OF THE INVENTION

Currently, many video cameras or video-type sensors are not environmentally aware. Numerous existing video processing systems do not produce results that correlate to real world coordinate systems. Further, current video processing systems that have the capability to output event data require several devices to accomplish such a function (e.g., a camera, a computer and other data processing devices must be utlized along with substantial manual configuration in order to produce event data in real world coordinate systems).

It is necessary to use environmental location information as a foundation for the integration of security data to assist in the fusing and integration of event and video data in order to provide security information. The environmental location information is the primary source that aids in the development of situational awareness. Many video surveillance systems do not have the functional capabilty to fuse disparate information into a single situational awareness framework. While there are systems that do have this capability, they are either highly expensive, custom built systems or they require substantial manual configuration in order to create environmental location data for video information.

By integrating disparate technologies into a single device, an environmentally aware video sensor can use automated algorithms coupled with publicly available data sources (i.e., global positioning system (GPS) data, atomic clock signals, etc . . . ) to maintain state data of the environment that is being monitered by the surveillance device. The acquired environmental state data can be used by vision processing algorithms to produce a stream of event data in terms of a real world coordinate system that is output directly from the surveillance device.

### SUMMARY OF THE INVENTION

The invention relates to methods and systems that utilize an environmentally aware surveillance device, wherein the surveillance device uses video technology to observe an area under surveillance and processes video (or any other media that records, manipulates or displays moving images) to produce outputs including streaming video as well as a stream of deduced event data. The event data may include facts about what was observed in the area under surveillance, where it was observed in the area under surveillance and when it was observed in the area undersurveillance, wherein the data is consistent from surveilled event to event.

An embodiment of the present invention comprises an environmentally aware surveillance device, wherein the device comprises a surveillance sensor for detecting objects within an area under surveillance. The environmentally aware surveillance device further comprises an environmental awareness means that is operative to self-determine the position and orientation of the surveillance sensor relative to a real world spatial coordinate system, for associating a position of an object detected by the surveillance sensor with respect to the real world spatial coordinate system, and for generating an event information output corresponding to the detected object and associated position. An output port provides event information to an external utilization system.

Another embodiment of the present invention comprises a self-contained stand alone environmentally aware surveillance device that is operative to provide event information as an output. The surveillance device comprises a surveillance sensor that provides event data of objects in an area under surveillance that are detected in an area under surveillance. A time circuit determines the time the surveillance events provided by the surveillance sensor were detected and a position information source self-detects the physical location of the surveillance device in a geographic coordinate system.

Other aspects of the surveillance device include a sensor orientation source that is operative for detecting the relative position of the surveillance sensor with respect to the geographic coordinate system. A processor is responsive to signals from the surveillance sensor, the clock receiver, the position sensor and the sensor orientation sensor, wherein the signals are processed and in response event information is generated that corresponds to a detected event that is detected by the sensor. The event information comprises attributes of objects identified by the surveillance signals, time information, and position information with respect to a detected event in an area under surveillance. Further, an output port is utilized to provide the event information for external utilization.

A further embodiment of the present invention comprises an environmentally aware sensor for a surveillance system. The sensor comprises a video sensor for providing video signals detected in the field-of-view of an area that is under surveillance. A global positioning system receiver is also implemented, wherein the receiver obtains position information from a global positioning system that is relative to a geographic coordinate system. The sensor also comprises an inertial measurement unit that detects the relative position of the video sensor and a camera lens situated on the video sensor, the camera lens having predetermined optical characteristics.

Additional aspects of the present embodiment include a clock receiver that receives and provides time signals. A computer processor that is responsive to signals from the video sensor, position signals from a position information source receiver, position signals from the orientation information source receiver, time signals from the clock receiver, and predetermined other characteristics of the sensor, executes predetermined program modules. A memory that is in communication with the processor stores the predetermined program modules for execution on the processor utilizing the video sensor signals, position information source position signals, orientation information source signals and the time signals.

The processor is operative to compute stored program modules for detecting motion within the field-of-view of the video sensor and detect an object based on the video signals in addition to tracking the motion of the detected object. The processor further classifies the object according to a predetermined classification scheme and provides event record data that comprises object identification data, object tracking data, object position information, time information, and video signals associated with a detected objected. The tracked object is correlated to a specific coordinate system. Thereafter, an object that has been identified and tracked is mapped from its 2D location in a camera frame to a 3D location in a 3D model. A data communications network interface for provides the event record data to an external utilization system.

An additional embodiment of the present invention comprises an environmentally aware video camera. The video camera monitors an area under surveillance (AUS) and provides for video output signals of the AUS. An environmental awareness means is featured, wherein the environmental awareness means is operative to self determine the position, orientation, and time of the video camera relative to a real world spatial and temporal coordinate system, and for generating event information corresponding to the position and time of the AUS by the video camera. Further, an output port provides the event information and video signals to an external utilization system.

A yet another embodiment of the present invention comprises an environmentally aware sensor system for surveillance. The system comprises a video sensor that provides video signals that correspond to a field-of-view of an area under surveillance and a computer processor. A position information input is utilized in order to receive position signals that are indicative of the location of the system with respect to a real world coordinate system, additionally an orientation information input is provided for receiving orientation signals that are indicative of the orientation of the video sensor relative to the real world coordinate system. Program modules are operative to execute on the computer processor, the modules including a video processing module for detecting motion of a region within the field-of-view of the sensor; a tracking module for determining a path of motion of the region within the field-of-view of the sensor; a behavioral awareness module for identifying predetermined behaviors of the region within the field-of-view of the sensor; and an environmental awareness module responsive to predetermined information relating to characteristics of the video sensor, said position signals, and said orientation signals, and outputs from said video processing module, said tracking module, and said behavioral awareness module, for computing geometric equations and mapping algorithms, and for providing video frame output and event record output indicative of predetermined detected conditions to an external utilization system.

A yet further embodiment of the present invention comprises a method for determining the characteristics of an object detected by a surveillance sensor in an AUS. The method comprises the steps of self determining the position, orientation, and time index of signals provided by the surveillance sensor, based on position, orientation, and time input signals, relative to a predetermined real world spatial and temporal coordinate system and detecting an object within the AUS by the surveillance sensor. Lastly, the method provides event information to an external utilization system, the event information comprising attributes of objects identified by the surveillance signal from the surveillance sensor, information corresponding to attributes of the detected object, and position information associated with the detected object relative to the predetermined real world spatial and temporal coordinate system.

A yet another embodiment of the present invention comprises a method for providing object information from a sensor in a security-monitoring environment for utilization by a security monitoring system. The method comprises the steps of placing an environmentally aware sensor in an AUS, the sensor having a range of detection and predetermined sensor characteristics, and inputs for receipt of position information from a position information source and orientation information from an orientation information source and at the environmentally aware sensor, self determines the location of the sensor relative to a 3D real world coordinate system based on the position information and the orientation information. Further, the method determines the 3D coordinates of the area within the range of detection of the environmentally aware sensor based on the predetermined sensor characteristics and the determined location of the sensor and detecting an object within the range of detection of the environmentally aware sensor. The 3D location of the detected object within the range of detection of the environmental sensor is determined and the location of the detected object is provided, identifying information relating to the detected object, and a data feed from the environmental sensor to the external security monitoring system.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates an area under surveillance as would be monitored by an environmentally aware surveillance device constructed in accordance with embodiments of the present invention.

FIG. 2 illustrates a camera 2D view and a 3D model of an area under surveillance that is facilitated by use of an environmentally aware surveillance device that is constructed in accordance with the present invention.

FIG. 3 illustrates an aspect of the mounting of a surveillance device in accordance with the invention, including an aspect for mapping a 2D image to a 3D model.

FIG. 4 illustrates a process flow for data captured by a camera to a 3D model.

FIG. 5 illustrates system components of an environmentally aware surveillance device constructed in accordance with embodiments of the present invention.

FIG. 6 is a flow chart of a computer-implemented process employed in an aspect of an environmentally aware surveillance device constructed in accordance with embodiments of the present invention.

FIG. 7 illustrates an embodiment of an environmentally aware survelleilance device and various external information sources that are utilized within embodiments of the present invention.

FIG. 8 illustrates an environmentally aware surveillance system and the components for an environmentally aware surveillance device constructed in accordance with embodiments of the present invention.

FIG. 9 illustrates aspects of a basic lens equation that can be used within embodiments of the present invention.

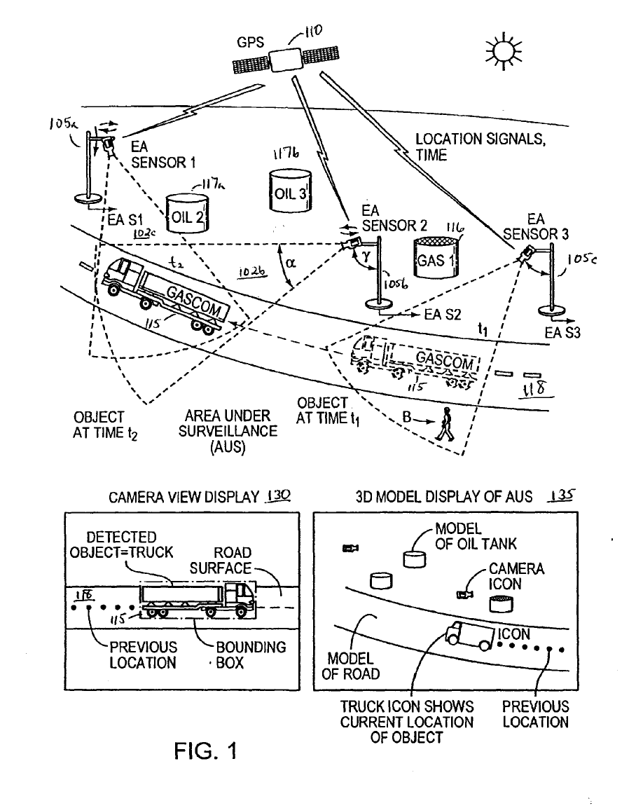

FIG. 1 0 illustrates aspects of the lens equation plus other aspects and/or parameters of the mounting of an environmentally aware surveillance device constructed in accordance with embodiments of the present invention.

FIG. 11 illustrates a method for determining the characteristics of an object detected by a surveillance sensor in an area under surveillance that relates to embodiments of the present invention.

FIG. 12 illustrates yet another method for providing object information from a sensor in a security monitoring environment for utilization by a security monitoring system that relates to embodiments of the present invention.

### DETAILED DESCRIPTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

### DEFINITION OF TERMS

Area Under Surveillance—an area of the real world that is being observed by one or more sensors.

Camera Sensor—a device that observes electromagnetic radiation and produces a two-dimensional image representation of the electromagnetic radiation observation.

Camera Image Frame—a two-dimensional image produced by a camera sensor.

2D Location—a location in a camera image frame; also referred to as screen coordinates as a camera image frame is frequently displayed on a video screen.

Video Sensor—a camera sensor that makes periodic observations, typically having a well-defined observation frequency that produces video output.

Video Output—a sequence of camera image frames, typically having been created at a well-defined observation frequency.

Event—an event is a logical representational indicator denoting that someone, something, or some sensor observed an happening, occurrence, or entity that existed at a point in time at a particular location. The event is distinct and separate from the actual happening that occurred. The particular incident may have been observed by multiple observers, each observer having a different perspective of the incident. Since the observers can have different perspectives of the incident each observer may notice different or conflicting facts in regard to the incident.

Event Information—event information describes characteristics that are determined by an observer that pertain to the event including but not limited to accurate, real world coordinates that have occurred at accurate, real world points in time. Event information is also called event data.

Event Record—an event record is an information record that is created to detail important event information for detected events that occur within an area under surveillance.

Object—an object is an entity that can be observed by a sensor that exists at a set of physical positions over a time period, regardless of whether the positions of the object change over time or not.

Detected Object—An object, typically a moving object, which has been observed by a sensor whose positions over time are stored as an object track.

—Moving Object—an object whose position changes over time.

Object Track—an object track is a set of event records where each event record corresponds to the position of an object within area of surveillance observed by a sensor over a specific period of time.

Three-dimensional model—a three dimensional model of an area under surveillance having a well-defined coordinate system that can be mapped to a measurable or estimated coordinate system in the real world by a well-defined mapping method.

Three-Dimensional Information—event information where the position of the represented object is described in terms of the coordinate system used in a three-dimensional model.

Position Information Source—position information source describes sources of location information that are used to assist in the implementation of location the environmental awareness functionality of the present invention. Examples of sources for position information include but are not limited to position sensors, GPS devices, a geographic position of a person or object, conventional surveying tools, Graphical Information System databases, information encoded by a person, etc.

Orientation Information Source—sources of orientation information that are used to assist in the implementation of orientation of the environmental awareness functionality of the present invention. Examples of sources for orientation information include but are not limited to orientation sensors, inertial measurement units (IMU), conventional surveying tools, information encoded by a person, etc.

Self-Determine—self-determine means using the methods and information sources used in the patent application, including the use of information from external sources, sensors and in some cases operators.

Environmental Location Information—information about the location of objects with respect to a known real-world coordinate system.

Situational Awareness Framework—a three-dimensional model of an area under surveillance to which detected object locations are mapped for a given area under surveillance.

System Overview

The term environmental awareness as presently used to describe the functions of the present invention, is defined as a surveillance device that has the capability to accurately and automatically determine the position, orientation and time index with respect to the real world for the device and the area under surveillance by the device. The environmental awareness of a surveillance device may be determined automatically by the device through the use of a combination of automatic sensing technologies in conjunction with a plurality of pre-programmed algorithms and device characteristics. The surveillance device utilized in conjunction with the present invention can include but are not limited to video cameras, audio listening devices, sonar, radar, seismic, laser implemented, infrared, thermal and electrical field devices.

The environmentally aware, intelligent surveillance device of the present invention observes objects, detects and tracks these objects, finds their two-dimensional (2D) location in a camera image frame, and thereafter determines the 3D location of those objects in a real-world coordinate system. In order to do this, the invention must take external inputs from the world and from external systems, wherein the inputs are described in further detail below.

Utilizing the environmental awareness capabilities, a device may identify moving or stationary objects within an environmental sensor's area of surveillance and as a result produce event information describing characteristics of the identified object in accurate, real world coordinates that have occurred at accurate, real world points in time. Identified characteristics can include position, type, speed, size and other determined relevent object characteristics. Sections of an area under surveillance may provide differing levels of interest wherein some sections may be evaluated to be of a level of higher interest than other areas. Embodiments of the present invention process information that defines such areas of interest by way of data that is obtained either manually or from an external system.

The enhanced environmentally awareness capabilities of the present invention allow the invention to determine the position of observed objects in accurate, real world coordinates in addition to determining the time the objects were observed in accurate, real world time. These environmental awareness characteristics may be provided to the device from external sources such as a position information source provider, an international time services provider or by internal sensing devices such as intertial measurement units (e.g., gyroscopes).

Components that may be utilized within embodiments of the present invention to facilitate the evironment awarness functinality of the present invention include but are not limited to: a position information source, an inertial measurement unit (IMU) comprising gyroscopes and accelerometers or other technology that is functionally equivalent and able to determine 3-dimensional orientation and movement, camera lens (the cameralens having known focal length or zoom with focal length feedback provided by a lens position sensor, e.g. see FIG. 8), a video sensor (e.g., either a digital video sensor or a frame grabber used in conjuntion with an analog video sensor that produces video signals), a clock receiver (or equivalent date and time source), a computer processor, a computer memory, a TCP/IP network interface card, video processing algorithm means, geometric mapping algorithm means and a video frame grabber. Lenses used within embodiments of the present invention may be manually or automatically focused in addition to manual aperture control or automatic control. Further, the lenses may have manual zoom (control of focal length) or automatic zoom along with a short or long depth of field.

Currently, there are many different coordinate systems that are utilized to provide coordinate data. The present invention may create security event data in terms of a specific prevailing global coordinate system. The present invention also allows for the selection of a primary coordinate system, wherein all event data processed within the invention may be delivered in terms of this coordinate system. A system operator or manufacturer may also be able to select a coordinate system from various coordinate systems that may be utilized in conjunction with the present invention. Alternative embodiments of the present invention that use different coordinate systems and create output events in terms of multiple coordinate systems, or that provide conversions or conversion factors to other coordinate systems are additionally provided as aspects of the alternative embodiments.

Further, an enviromentally aware sensor device may have the capability to be self-configuring by utilizing a combination of data that is automatically available from external sources, from internal sensing devices, pre-configured device characteristics and intelligent sensor analysis logic that is at the disposal of the device. Additionally, if necessary, the environmentally aware sensor device may be configured by a system operator via either a graphical user interface displayed at a work station console or a web browser.

Embodiments of the present invention may perform further aspects such as vision processing by using predetermined algorithms to carry out tasks such as as image enhancement, image stabilization, object detection, object recognition and classification, motion detection, object tracking, object location and object location. These algorithms may use environmental awareness data and may create an ongoing stream of security event data. Event records can be created for important detected security events that occur within the area under surveillance. An event record may contain any and every relevant fact about the event that can be determined by the vision processing algorithms.

In order to provide the consistency of data in regard to events relating to the same physical object or phenomenon within the AUS, device state data can be maintained by the device, wherein acquired state data can be compared and combined during an external analysis. Generated event data may be published in an open format (e.g., XML) in addition to or along with an industry standard output (e.g., such as MPEG standards define). Each event record may by time-synchronized in accordance with the video signal input that was processed to determine the event.

Environmental awareness data that is acquired by the present invention (such as position, angle of view (3D), lens focal length, etc . . . ) evaluated in conjunction with coordinate mapping models to convert observed event locations from 2D sensor coordinates into accurate 3D events in a real world coordinate system. Since various coordinate systems are utilized within the present invention, the coordinate systems used within the present invention may be configurable or selectable at the discretion of a system operator.

A further aspect of embodiments of the present invention is the capability of the present invention to produce video data in digital or analog form. Video data may be time-synchronized with security event data that is also produced by the present invention. This capability allows in particular instances for external systems to synchronize their video processing or analysis functions with event data that is produced by the present invention. Input/output connections are also provided for embodiments of the present invention. The input/output connections may include, but are not limited to, connections for analog video out, an Ethernet connection (or equivalent) for digital signal input and output and a power in connection.

Within embodiments of the present invention, the computer processor may accept position input data from a position information source and orientation input data from an orientation information source. The processor may combine this input data with the lens focal length, acquired video sensor information in addition to user configuration information to modify the geometric mapping algorithms that may be used within the present invention. The resultant processed environmental awareness data may be stored in a computer memory that is in comunication with the computer processor. Additionally, embodiments of the present invention may obtain digital video input directly from the video sensor or from a frame grabber, wherein the video input is obtained at a configurable rate of frames per second.

A specific video frame may be processed by the computer processor by a program that uses video processing algorithms to deduce event data. State information, as needed, can be deduced, maintained and stored in the computer memory in order to facilitate deductions and event determination. Thereafter, deduced event records and streaming video can be time synchronized, generated, and sent over the TCP/IP interface.

Within embodiments of the present invention, the outputs of a position information source, a video sensor, an orientation information source and an atomic clock receiver are fed into a computer processor (using a video frame grabber, if necessary). The computer processor executes a program, wherein the program consists of a number of specific processing elements. One of the processing elements will preferrably include video processing algorithms for carrying out specific operations such as image stabilization, motion detection, object detection, object tracking and object classification.

Video images captured from the video sensor are processed one frame at a time. Objects are identified by the video processing algorithms and as a result an event record is created that contains facts about each identified object. The actual time that the video frame was captured is determined, based on information from the atomic clock receiver, and set in the event record. Specific facts such as object height, width, size, orientation, color, type, class, identity and other characterists are determined and recorded in the event record. Additional pre-determined information may be gathered and added to the event record by adding vision processing algorithms that can process the incoming object data for the pre-determined information.

Event records may contain, but are not limited to, the following attributes: Sensor ID
Time and Date
Sensor Azimuth
Sensor Tilt
Sensor Zoom
Event Type
Event Name
Event ID
Coordinate System Type
Object ID
Object Type
Object Activity
Object Location (X,Y,Z coordinates)
Object Height
Object Width
Object Direction
Object Speed
Object Shape
Object Color
Object Characteristics
Object Location

As vision processing algorithms advance, it is expected that higher accuracy and more complete security event data will be produced using these new algorithms. It is expected that these algorithms can be easily implemented within embodiments of the present invention by replacing and/or augmenting the algorithms as defined herein. It is also expected that communication protocols and standards for the communication of security events may evolve over time. These new protocols and standards are also envisioned as being utilized within embodiments of the present invention. Further, sensing technologies, in addition to those currently listed, are likely to become available. In particular, any use of multiple cameras, different lens technology, multi-mode video sensors, multiple video sensors, laser range-finding, physical positioning sensors, replacements for position information source technology, radio direction-finding, radar, or similar devices can be used in variant implementations of the present invention.

It is possible to use a wide variety of vision processing algorithms for the detection, tracking, classification, and behavior analysis functions of the invention. These vision processing algorithms could range from very rudimentary or simple algorithms to very sophisticated algorithms. Embodiments of the present invention comprise aspects wherein no behavioral analysis or classification algorithms are implemented and the invention retains the ability to function as described.

Embodiments of the present invention further comprise inventive aspects that allow for the environmentally aware surveillance device or system to transmit and receive information from external identification systems. In particular, identification systems that provide identity information based upon characteristic information may be accessed in order to enhance the capabilities of the present invention. Examples of such identification systems include, but are not limited to, fingerprint recognition systems, facial recognition systems, license-plate recognition systems, driver's license databases, prison uniform identification databases or any other identification system that identifies a specific individual or individual object based upon the individual's characteristics.

Information obtained from an external identification system would be used by the vision processing algorithms such that the object ID delivered with an internal system security event would be consistent with the ID used by the external, characteristic-based identity system. It is likely that many variations of external identification systems might provide valuable information that would be useful when used in conjunction with the vision processing algorithms embedded within the present invention. Identification data relating to aspects such as facial recognition, license plate identification, gait identification, animal identification, color identification, object identification (such as plants, vehicles, people, animals, buildings, etc.) are conceivable as being utilized within embodiments of the present invention.

By an external identification system, the present invention could identify the specific instance of an object or event is observed along with the type of object or event that is being observed within the surveillance area. In the event that an external identity system is not available for use, the vision processing algorithms within the present invention may create their own object ID for the object types that can be identified. In the event that an external identity system is available to provide identification for specific characteristics of object types, then the invention may use the external instance object ID for the object identified.

The present invention would typically not have access to topographical information unless a system operator supplied the topographical information at time of the configuration system. In other embodiments of the present invention, the device would interact with an external Graphical Information System (GIS) in order to obtain topographic information for the area under surveillance. This topographic information defines the relative heights for all the points in the area under surveillance. The topographic information would be used in conjunction with additional environmental awareness data in order to provide more accurate 2D to 3D coordinate mapping without requiring additional operator input.

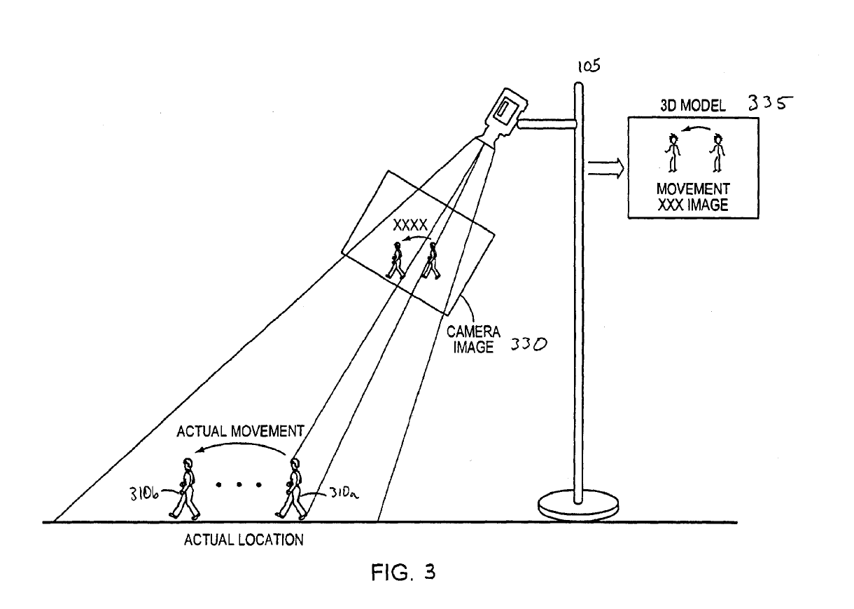

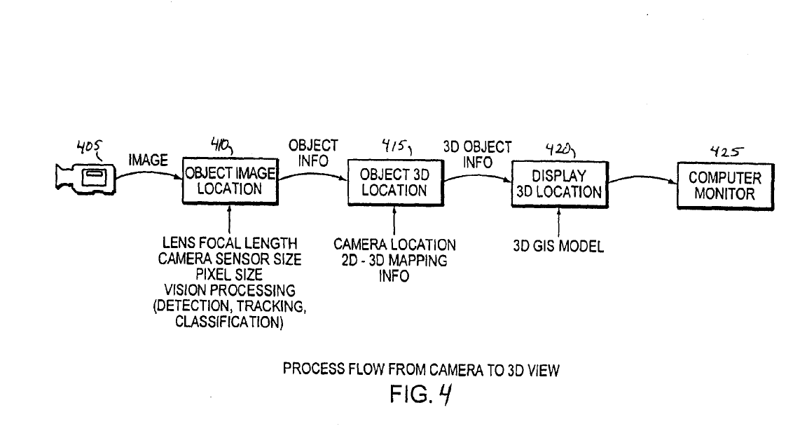

FIGS. 1 and 3 illustrate an embodiment of an environmentally aware intelligent surveillance device system 100 and an environmentally aware sensor 105. As presented in FIG. 1, the system 100 comprises three environmentally aware sensors 105a, 105b and 105c. The sensors illustrated within FIGS. 1 and 3 are camera-type sensors, wherein the sensors 105, 105a, 105b and 105c are positioned atop poles. Positioning the sensors 105a, 105b and 105c in this manner allows for the sensors to more easily monitor designated areas. The sensors 105a, 105b and 105c would normally be installed in a single position, wherein the sensor can have a predetermined range of motion in order to view a predetermined circumscribed area. In additional embodiments, the sensors can be installed on a moving platform. In that instance, the video processing, tracking, and location awareness algorithms are be enhanced to handle ongoing inputs from the IMU in order to correct for changes in the device orientation while determining object facts (e.g., object location, speed, etc . . . ).

The positional information source is in this example provided by a GPS satellite 110 that is in communication with the environmental sensors 105a, 105b and 105c. The GPS satellite 110 provides location data in regard to the geographic location of the environmental sensors 105a, 105b and 105c to the sensors. This location data is used in conjunction with acquired surveillance sensor data of a monitored object to provide environmentally aware surveillance data that is associated with the object under surveillance.

For example, FIG. 1 illustrates a geographic area wherein the sensors 105a, 105b and 105c are located. Also located in the area are two oil storage tanks 117a, 117b and a gasoline storage tank 116. The tanks 116, 117a and 117b are permanent structures that are located in the geographic area, and a road 118 transverses the geographic area.

Each sensor 105a, 105b and 105c is configured to monitor a specific geographic area, in this instance sensor 105a monitors AUS 120a, sensor 105b monitors AUS 120b and sensor 105c monitors AUS 120c. As seen in FIG. 1, the various areas that are under surveillance may overlap in some instances as the movement of the sensors changes the areas that each sensor monitors.

One important aspect of the environmentally aware sensors 105a, 105b and 105c, and therefore their respective states, is the definition of what area in the real world the areas that the sensors are observing are located. By evaluating the mapping from points in the sensor's AUS views, such as those at the edge and on the corner points of the sensor using the same process for mapping object locations, the actual observation area seen by the sensor can be determined. This state information can be saved or it can be sent in an event message with other state information.

In the present example, the object that is being monitored by the system is a truck 115 that is traveling along the road 118 that passes through the respective areas that each sensor 105a, 105b and 105c are monitoring. Objects that are permanently located within the respective AUS that are monitored by the sensors are observed and identified within each AUS. The truck 115 is identified by the system as a foreign object, and as such its movements may be monitored by the surveillance system 100.

As the truck 115 enters an AUS the location and the time the location is located in the AUS is determined.

Time Data Acquisition And Utilization

Time data is obtained and used by the invention to synchronize the data received or produced by each component utilized within the embodiments of the present invention. This aspect of the present invention ensures that decisions made for a particular individual video frame are made using consistent information from the various sources within the system or device due to the fact that all other information that was observed and acquired was at the same real-world time as the time the video frame was taken. The phrase “same real-world time” is presumed to be accurate within some reasonable time interval that can be determined by a system operator. More specifically, the time index of each system or device component should be accurate to near one hundredth and no larger than one tenth of the time between video frames.

For time information to be synchronized between devices or components that are used within the present invention, they must initially obtain a time reference. Ideally, that time reference can automatically be communicated to each device or component. When this is not possible, a dedicated time receiver must receive the time reference and communicate the time to all devices or components.

The United States government sends a time reference signal via radio waves called the atomic clock signal, wherein all atomic clock receivers can receive this signal. A GPS system broadcasts reference time signals in conjunction with the GPS information that it broadcasts. Another alternative is to take time information from Network Time Protocol (NTP) public timeservers. This is a very cost-effective option due in part to the requirement that the invention must communicate the event information via a network output; this network may have access to an NTP server across the network. Further, it is expected that time synchronization technologies will improve in the future and that these improvements are similar in nature to those described herein.

Video Processing Algorithms

Video processing algorithms process video to identify objects that are observed in the video in addition to identifying and classifying those objects to individual types of objects (and in some cases the identity of individual objects) and tracking the motion of the objects across the frame of the video image. The results of these algorithms are typically denoted as event information in that the observation and determination of an object within the video frame is considered an event.

Each event determined by the vision processing can contain various characteristics of the object determined by the vision processing (e.g., height, width, speed, type, shape, color, etc . . . ). Each frame of video can be processed in order to create multiple events. Each object identified in a video frame may be determined to be a later observation of the same object in a previously processed video frame. In this manner, a visual tracking icon or bounding box may be constructed and displayed showing the locations of the object over time a time period by showing its location in each video frame in a sequence of frames.

The visual tracking icon's location and position are based upon gathered track data. A track is defined as a list of an object's previous positions, as such, tracks relating to an object are identified in terms of screen coordinates. Further, each identified object is compared to existing tracks in order to gather positional data relating to the identified object. The event information resulting from the video processing algorithms is transmitted as a stream of events, wherein the events for a given frame can be communicated individually or clustered together in a group of events for a given time period.

Lens Equations

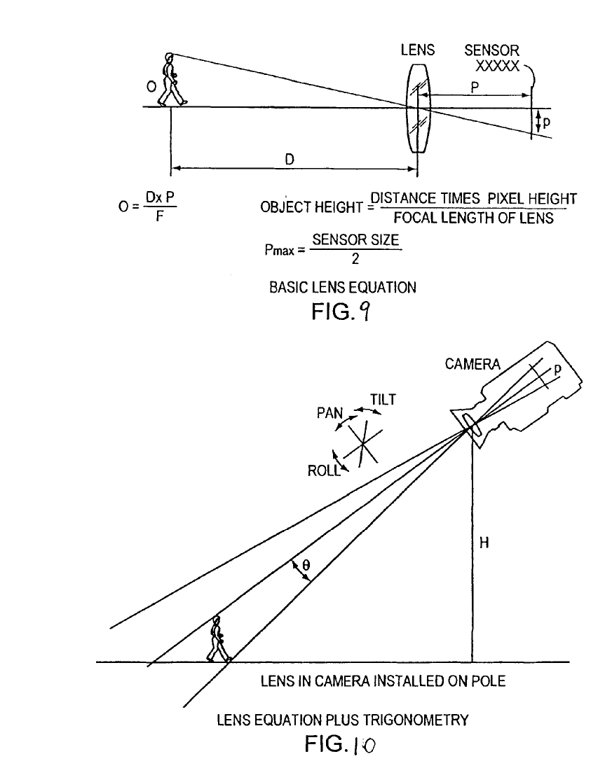

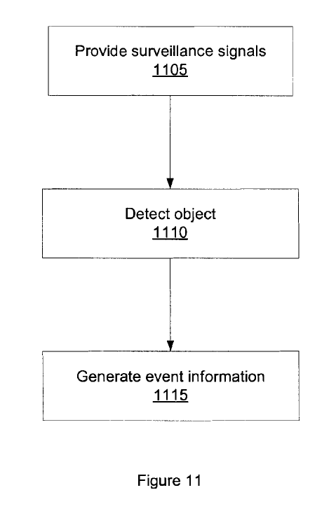

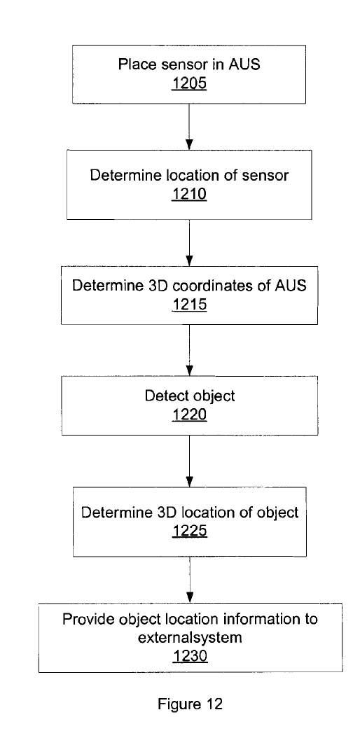

The location and size of an observed object can be determined by utilizing the specific parameters of the lens and video sensor of the environmentally aware surveillance device, the location and orientation of the environmentally aware surveillance device and the relative location of the object on the ground. A basic lens equation that may be utilized within embodiments of the present invention is shown in FIG. 9. FIG. 10 shows the application of the lens equation on an environmentally aware sensor device that is mounted some height above the ground. Using the basic lens equation, the size of the object captured by the video sensor is determined by the distance of the object from the lens, the size of the object, and the focal length of the lens.

When an environmentally aware sensor device is mounted above the ground at some orientation of pan, tilt and roll, trigonometry is used to determine the values to be plugged into the basic lens equation based on the angles of pan, tilt and roll as well as the height of the environmentally aware device. When an object is observed within the view of an environmentally aware sensor device, there are infinite combinations of object sizes and distances that can form the same image on the video sensor; this can be shown by solving for “D” using the basic lens equation for a fixed value of “P” while varying the value of “O”.

In order to bring the lens equation down to one specific value of “O” for a given observed value of “P”, an assumption is made that the identified object seen in the view is located on the ground. More specifically, the base of the detected object is assumed to be located on the ground. This allows use of the basic lens equation and trigonometry to determine a single value of “O” for the observed value of “P.” Since the video sensor is a 2D array of pixels, the calculations described above are done for each of those two dimensions, therefore resulting in a two-dimensional height and width of the object in real world dimensions.

Lens and Photo Sensor Information

Two of the key pieces of information required by the lens equation are the focal length of the lens and the size of the video sensor. The lens may be a fixed focal length lens where the specific focal length can be determined at the time of lens manufacture. The lens may be a variable focal length lens, typically called a zoom lens, where the focal length varies. In the instance that a zoom lens is utilized, the actual focal length at which the lens is set at any point in time can be determined if the lens includes some sort of focal length sensing device. The size of the video sensor is typically determined by its height and width of sensing pixels. Each pixel can determine the varying level of intensity of one or more colors of light. These pixels also typically have a specific size and spacing, so the size of the video frame is denoted by its height and width in pixels that determines the minimum granularity of information (one pixel) and the length of an object in pixels by multiplying the number of pixels times the pixel spacing.

Position Information

An environmentally aware surveillance device can be mounted virtually anywhere. Using the lens equations and trigonometry as described above, the location of an object can be determined in reference to the location of the environmentally aware surveillance device. In order to locate that object in some arbitrary real-world coordinate system, the position of the environmentally aware surveillance device in that coordinate system must be known. Therefore, by knowing the position of the environmentally aware surveillance device in an arbitrary coordinate system and by determining the location of an object in reference to the environmentally aware surveillance device position, the environmentally aware surveillance device can determine the location of the object in that coordinate system.

Position information is typically used in navigation systems and processes. The GPS system broadcasts positional information from satellites. GPS receivers can listen for the signals from GPS satellites in order to determine the location of the GPS receiver. GPS receivers are available that communicate to external devices using a standard protocol published by the National Marine Electronics Association (NMEA). The NMEA 0183 Interface Standard defines electrical signal requirements, data transmission protocol and time, and specific sentence formats for a 4800-baud serial data bus. GPS receivers are also available as embeddable receiver units in the form of integrated circuits or as mini circuit board assemblies. Further, it is expected that position information technologies will improve in the future and that these improvements are similar in nature to those described herein.

Orientation Information

As mentioned above, the pan, tilt, and roll of the environmentally aware surveillance device are necessary to the calculation of the trigonometry that is required to use the lens equation in order to determine the relative distance between and the size of an object and the environmentally aware surveillance device. More specifically, the pan, tilt, and roll are three measures of the angles in each of three orthogonal dimensions between the specifically chosen real world coordinate system and the three dimensions defined along the length and width of the video sensor and the distance that is perpendicular to the video sensor through the lens.

Orientation information is determined by measuring the angles in the three dimensions (pan, tilt, and roll dimensions) between the real world coordinate system and the video sensor. These angles can be measured only if the reference angles of the real world coordinate system are known. Therefore, an orientation sensor must be installed such that its physical orientation with respect to the video sensor is known. Then, the orientation sensor can determine the angle of the video sensor in each dimension by measuring the real world angles of the orientation sensor and combining those angles with the respective installed orientation angles of the vision sensor. In embodiments of the present invention, IMUs determine changes in orientation by comparing the reference angles of gyroscopes on each of the three dimensions to the housing of the environmental awareness device. As the housing moves, the gyroscopes stay put; this allows the angle on each of the three dimensions to be measured to determine the actual orientation of the housing at any time.

An alternative to an orientation sensor that is part of the device is to determine the orientation of the sensor at the time of installation. This determination can be made by the use of an orientation sensor, by measurement using some external means, or by calibration using objects of known size and orientation within the view of the sensor. The orientation information source can be a person who measures or estimates the necessary orientation values. Methods for measurement can be the use of bubble levels, surveying tools, electronic measurement tools, etc. Automatic measurement or calibration of orientation can be done by taking pictures of objects of known size via the video sensor then using trigonometry and algorithms to deduce the actual orientation of the sensor with respect to the real world coordinate system. It is expected that orientation information technologies will improve in the future and that these improvements are similar in nature to those described herein.

Mapping and Geographical Information System Information

As previously mentioned, a coordinate system is used as a reference for denoting the relative positions between objects. Coordinate systems are usually referred to as “real world coordinate systems” when they are used in either a general or specific context to communicate the location of real world objects. Examples of such coordinate systems are the latitude and longitude system and the Universal Transverse Mercator system.

Because trigonometry uses an idealized, 3D coordinate system where each dimension is orthogonal to the others and the earth is a sphere with surface curvature, there will be some error in mapping the locations on the sphere to orthogonal coordinates. By offering a system operator the choice of the real world coordinate system to implement, the operator is not only given the control of where these errors show up, but as well the units of the coordinate system that will be used.

The topographical information for the area viewed by the video sensor in the environmentally aware surveillance device is important mapping information needed by the device. Once the device knows its own position, it can use the topographical information for the surveillance area to determine the ground position for each point in the surveillance view by projecting along the video sensor orientation direction from the known video sensor height and field of view onto the topographical information. This allows the device to use topographically correct distances and angles when solving the lens equation and trigonometric equations for the actual object position and orientation.

GISs store systematically gathered information about the real world in terms of some (or many) real world coordinate systems. GISs are typically populated with information that has been processed from or determined by aerial photography, satellite photography, manual modeling, RADAR, LIDAR, and other geophysical observations. The processing of these inputs results in information that is geo-referenced to one or more real world coordinate system. Once a real world coordinate system is selected, a GIS can be accessed to gather topographic information showing the actual surface of the earth or information about the locations of specific environmental characteristics.

Several publicly available GIS databases are available either for free or for nominal fees to cover distribution media. The United States Geographical Survey (USGS) publishes GIS databases that include topographical information that include topographical information of the form needed by the environmentally aware, intelligent surveillance device. GIS databases including the USGS topographical information are frequently packaged by GIS vendors along with GIS tools and utilities. These packages provide more up-to-date GIS information in an easy to access and use manner via their respective tools packages. It is expected that topographical information technologies will improve in the future and that these improvements are similar in nature to those described herein.

State Message Output and State Information

Given that the environmentally aware sensor determines its position using the inputs and processes described already, it can maintain this state information (position, orientation, height, altitude, speed, focal length, for example). In particular, all information determined, observed, or deduced by the sensor from its sensing capabilities and all deductions, parameters, and conclusions that it makes can be considered state information.

The state information generated by the sensor can be used for decision-making functions and for implementing processes. The state information can also be used to test for the movement of the sensor. This aspect of the present invention is accomplished by comparing the state information for a current time period against the state information from a previous time period or periods, wherein thereafter the sensor can deduce its speed, direction, and acceleration. Further, the sensor has the capability to use state information to make predictive decisions or deductions in regard to future locations. The sensor can also send event messages either containing or referencing specific state information as additional output messages.

Mapping Objects From 2D to 3D

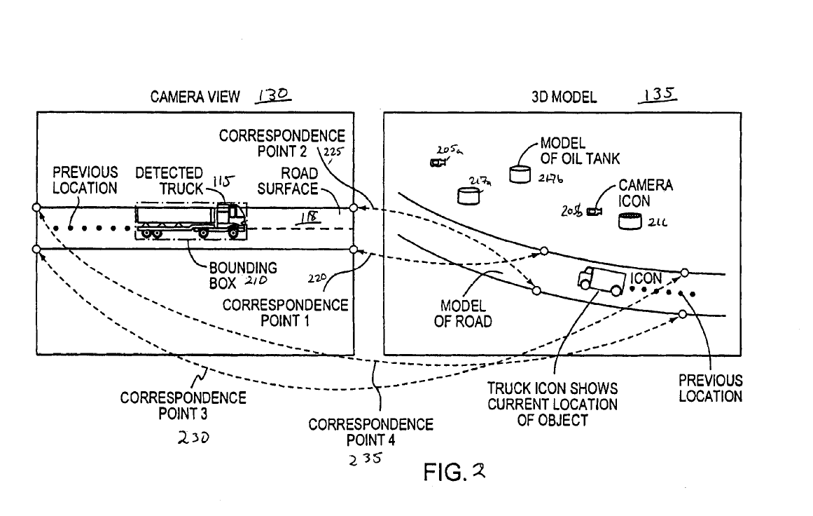

As shown in FIGS. 1 and 2, each object that is identified in a camera frame's event data is then mapped from its 2D location in the frame to its 3D location in a 3D model using the adjusted parameterized lens equation. The adjusted parameterized lens equation is created by using the position information, orientation information, lens information, photo sensor information, and topographical information determined to be accurate at the time the camera image was taken to fill in the appropriate values in the trigonometric equations representing the geometric relationship between the camera sensor, the object, and the three-dimensional coordinate system in the lens equation. By these calculations, the adjusted parameterized lens equation describes the relationship between the location of the object and the environmentally aware sensor. Since the sensor is located in the 3D model, the object is then located in the 3D model. The 3D location data for each object is then stored within the event data for the frame.

Since an object that appears on the 2D sensor frame can actually be a small object close to the lens or a large object far from the lens, it is necessary for the mapping system to make some deductions or assumptions about the actual location of the object.

For most surveillance systems, the objects being detected are located on or near the ground. This characteristic allows for the mapping system to presume that the objects are touching the ground, thereby defining one part of the uncertainty. The other part of the uncertainty is defined by either assuming that the earth is flat or very slightly curved at the radius of the earth's surface or by using topographical information from the GIS system. Taken together, the topographical information plus the presumption that the identified object touches the ground furnishes the last variables that are needed in order to use the adjusted parameterized lens equation to calculate the location of the object in the 3D model from its location in the 2D video frame. As an alternative to topographical information, specific points of correspondence between the 2D and 3D model can be provided from the GIS system and various forms of interpolation can be used to fill in the gaps between the correspondence points.

Environmental awareness calculations can be performed using 2D to 3D transformations that are stored in a lookup table. A lookup table generator tool creates a mapping of points within the 2D screen image (in screen coordinates) to locations within a 3D real world model in real world coordinates. The lookup table is a table that identifies the 3D world coordinate locations for each specific pixel in the screen image. The lookup table is generated at the time of configuration and then is used by the coordinate mapping function for each object being mapped from a 2D to 3D coordinate.

There are two cases that are handled by the environmental awareness module. The first case is where the user runs a manual lookup table generator tool in order to create a lookup table. The second case is where the lookup table is automatically generated using the sensor's inputs from the position information source and orientation information source along with the pre-configured lens data. Within embodiments of the present invention, both of these cases are combined such that the lookup table is automatically generated from the sensor inputs and this is only overridden when the user desires specifically entered 2D to 3D mappings.

Embodiments of the present invention utilize representative manual lookup table generation tools. The lookup table generator uses control points to identify specific points in the 2D screen that map to specific points in the 3D world. These control points are entered by the user via a graphical user interface tool, wherein the user specifies the point on the 2D screen and then enters the real world coordinates to which that point should be mapped.

During the ongoing processing, the environmental awareness module maps object locations from the 2D camera frame coordinate locations identified by the tracking module into 3D world coordinates, wherein this function is accomplished using the lookup table. As mentioned above, within embodiments of the present invention the object tracking algorithm performs the steps of adding the new object to the end of a track once the track is located. Thereafter information about the object is collected and mapped from pixel to world coordinates and the speed and dimensions of the object are computed in the world coordinates and then averaged.

After the environmental awareness module completes processing, the information generated for each object detected and analyzed within the video frame is gathered. The event information is placed in the form of an XML document and is communicated to external devices using the user-configured protocol. The video frame is marked with the exact date and time and sensor ID that is used within the event records generated from that frame and the video frame is communicated using the user-configured video protocol (either analog or digital).

As shown in FIG. 1, t1 represents the time period that the truck 115 was located in AUS 120a and t2 represents the time period that the truck 115 was simultaneously located in AUS 102b and 102c. As the truck 115 travels through the AUS 120a, 120b and 120c, data is collected in reference to the identified foreign object that is the truck 115.

The image of a particular AUS that is captured by an environmental sensor 105a, 105b and 105c can be displayed to a system operator, as illustrated by the camera display view 130 (FIGS. 1 and 2). Further, the 2D image as captured by the sensors 105a, 105b and 105c is used to subsequently construct a 3D model display 135 of the sensor image. As shown in FIG. 2, a bounding box 210 in the sensor view 130 highlights the detected truck 115. The corresponding points of the AUS as viewed within the sensor view 130 and the 3D model view 135 are noted by the points 220, 225, 230 and 235 of FIG. 2. The points 220, 225, 230 and 235 aid in highlighting the previous and current position of the detected object (the truck 115 in this instance) as viewed within the 3D model 135 of the sensor view 130. Models of the sensors 105a and 105b as well as the tanks 116, 117a and 117b are displayed on the 3D model as 205a, 205b, 216, 217a and 217b, respectively.

FIG. 4 illustrates a process flow showing the flow of a 2D image 330 captured by the sensor (which in this instance is a camera) 405 of an individual as they move through an AUS 310a and 310b to the 3D view 335 that is constructed of the surveillance area. This process is further illustrated in FIG. 4, wherein the image data that is acquired by the sensor 405 is employed at process 410 in conjunction with other pre-specified information (e.g., lens focal length, pixel size, camera sensor size, etc . . . ) in order to generate information in regard to an observed object.

The generated information is used at process 415 in conjunction with acquired sensor 405 location information and 2D-to-3D mapping information in order to generate 3D object event information in regard to the observed object. A process for mapping 2D-to-3D information is specified in detail below. At process 420, this 3D object event information is used in conjunction with a 3D GIS model in order to generate a 3D display image of the observed objects location, wherein at process 425 and as discussed in detail below, a 3D model 135 that displays a specific AUS can be constructed within the system and displayed to a system operator.

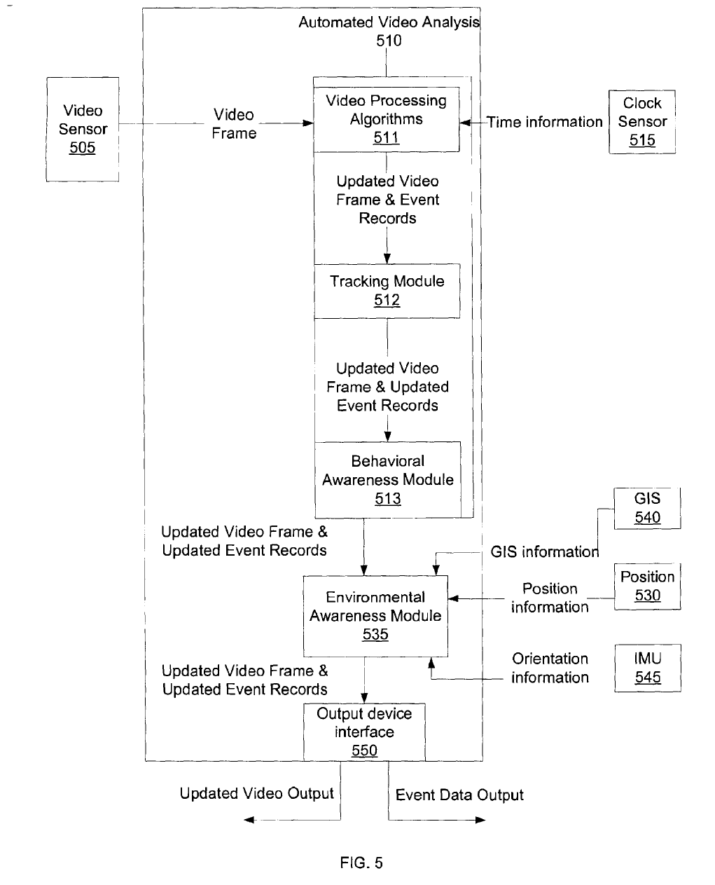

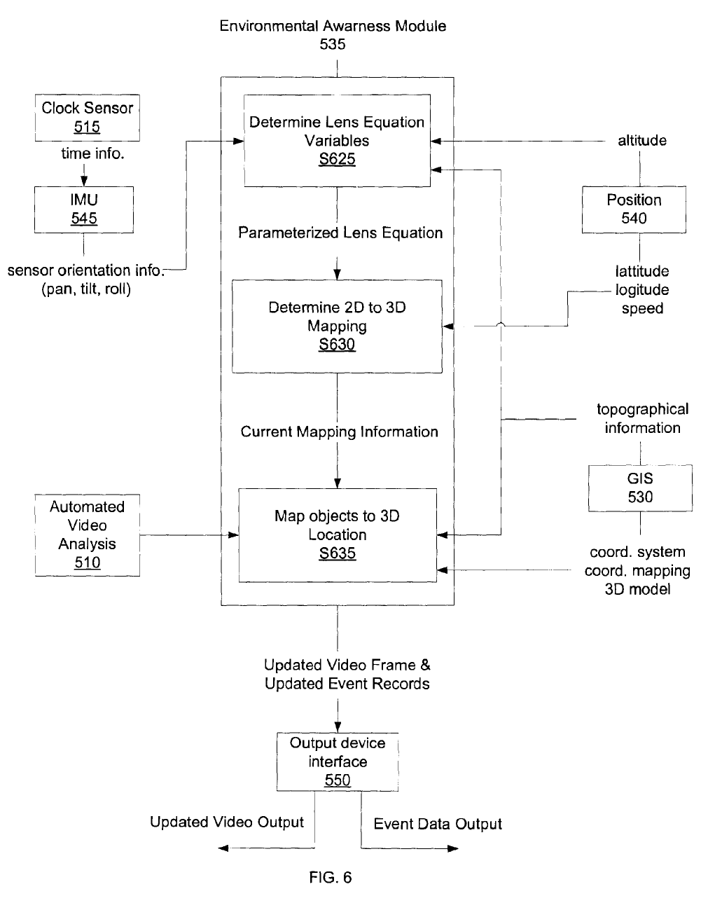

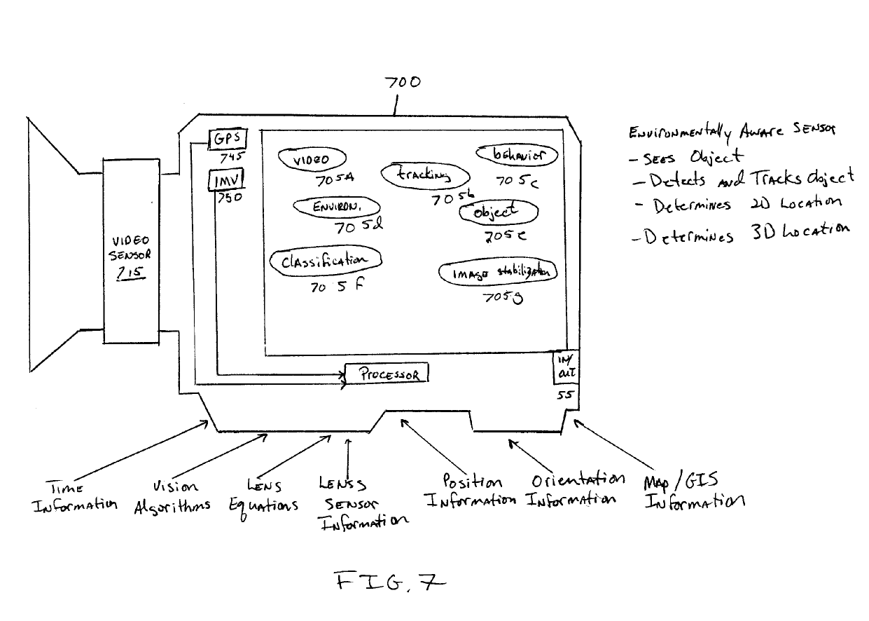

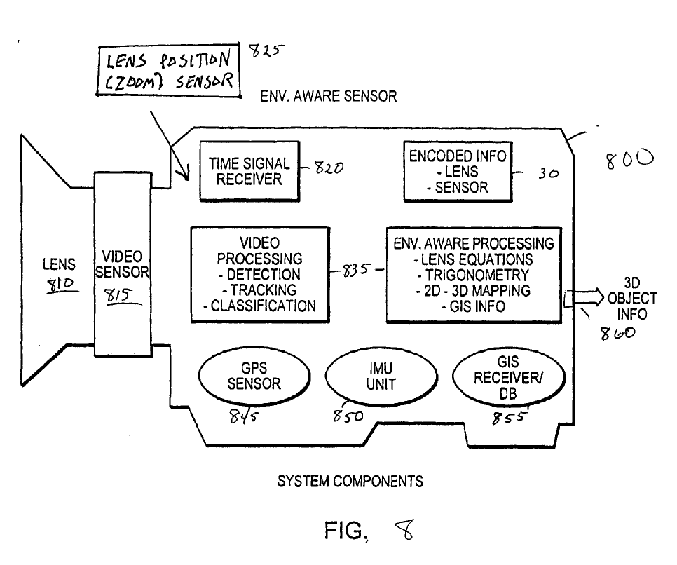

As illustrated in FIGS. 5 and 6, the outputs of the position information source 540, video sensor 505, IMU 545 and the atomic clock sensor 515 are fed into a computer processor (not shown), wherein the computer processor is in communication with the computer memory (not shown). A program residing in the computer memory is executed by the computer processor, the program consists of a number of specific processing elements or modules. As mentioned above, one of the processing modules preferrably includes an automated video analysis module 510 for carrying out sub-module operations via video processing algorithms 511, as image stabilization, motion detection, object detection, and object classification. Additional sub-modules that can reside in the memory are the object tracking module 512 and a behavioral awareness module 513.

As illustrated in FIG. 5, a video frame is acquired and transmitted from the video sensor 505 to the memory wherein the acquired frame is analyzed via the automated video analysis module 510. Time information pertaining to the time the respective video frame was acquired is transmitted from the atomic clock sensor 515 to the automated video anlysis module residing in the memory, wherein the actual time that the video frame was captured is determined and set in the event record. The time information is used in conjunction with the video processing alogrithms sub-module 511 to aid in performing the image stabilization, motion detecton, object detection and object classification algorithmic functions of the video processing sub-module. Additonally, facts such as object height, width, size, orientation, color, type, class, identity, and other similar characterists are determined and placed in the event record.

As shown below, the object classification algorithms may be executed within various sub-modules of the system, because as each processing algorighm runs, additional features and data about detected objects become available that allow for more accurate object classification. Video frames may be updated by the video processing algorithms to include visual display of facts determined by the processing algorithms. Upon the completion of the frame processing, the video frame information is update and an updated event record of the frame information is generated. This information is passed to the object tracking sub-module 512, wherein objects that have been identified within the video frame are processed via the object trackng algorithms and further object classification algrtihms. One of ordinary skill in the art would recognize that other object classification algorithms can be implemented as substitutes in place of the one described herein.

The object tracking sub-module 512 contains an object tracking algorithm that provides input data for the environmental awareness of the sensor. The algorithm integrates with other vision processing algorithms to first identify the screen coordinate location of the object (the location on the video sensor or what would be shown on a screen displaying the video). Each identified object in each frame is compared to objects found in previous frames and is associated to the previously identified object that most accurately matches its characteristics to create an object track. An object track is the location of an identified object from frame to frame as long as the object is within the area under surveillance.

The present invention maintains a state history of the previously detected positions of objects in the form of tracks. As mentioned above, a track is defined as a list of an object's previous positions, as such, tracks relating to an object are identified in terms of screen coordinates. Each identified object is compared to existing tracks. In the event that an object is determined to match that track, it is added as the next position in the track. New tracks for identified objects are created and inactive tracks for objects are deleted as required. One of ordinary skill in the art would recognize that any capable tracking algorithm can be used in place of the one described herein.

Video frames may be updated by tracking algorithms to include visual display of facts determined by the algorithms. As previously mentioned, because as each processing algorighm is executed more additional features and data about detected objects may become available that allow for more accurate object classification an object classification algortim further analyzes the information.

Again, upon the completion of the frame processing anlaysis by the object tracking sub-module 512 the video frame information is updated and an updated event record of the frame information is generated. The resulting video frame and event record information is passed to the behavioral awareness module 513, wherein the video frame is further analyzed via behavioral identification algorithms and further object classification algorithms.

The behavioral awareness sub-module 513 may analyze the object tracking information to identify behaviors engaged in by the objects. The behavior analysis algorithms may look for activity such as objects stopping, starting, falling down, behaving erratically, enterring the area under surveillance, exiting the area under surveillance, and any other identifiable behavior or activity. Any facts that are determined to be relevant about the object's behavior may be added to the event record. One of ordinary skill in the art would be able to choose from many available behavior identity algorithms.

Once the object and its behavior has been identified and tracked to screen coordinates, the object will be further processed by the environmental awareness module 535. As illustrated in FIG. 6 the environmental awareness module 535 uses information from the IMU 545 to determine the orientation (pitch, roll, and direction) of the video sensor at step 625. Also at step 625 the environmental awareness module 535 also uses information about the focal length of the lens (either pre-programmed into the computer memory at the time of manufacturing or available from the lens transmiting the information directly to the computer processor).

In further aspects of the present inveniton at step 625 the environmental awareness module 535 uses information from the position information source 540 to determine the position of the sensor (including height above the ground). At step 630 this information is combined with object position identified by the tracking module, lens equations, equations that can convert between the coordinate system utilized by the position information source and the selected world coordinate system, geometric mapping algorithms, and known characteristics of the video sensor in order to determine the location of the object in real world coordinate systems. Facts such as object location, object direction, object speed, and object accelleration may be determined by the tracking and environmental awareness modules. The video frames may be updated by the environmental awareness algorithms to include visual display of facts determined by the algorithms.

The latitude/longitude coordinates submitted by the position information source 540 are converted to the coordinate system of a 3D model and thereafter at step 635 using the coordinate mapping equations, functions, or information submitted by the GIS system 530 an observed object is mapped to a 3D location. The parameterized lens equation is also similarly converted to the coordinate system of the 3D model using the same coordinate mapping process to create the adjusted parameterized lens equation. The current mapping information is defined by the adjusted parameterized lens equation plus the coordinate mapping process.

The information generated by the tracking and location awareness modules are added to the event record created by earlier processing modules. A globally unique identifier may be programmed into the computer memory at the time of manufacturing. This identifier may be added to the event record as the sensor ID. The coordinate system type in which the location coordinates have been defined may additionally be added to the event record.

For each frame processed by the computer program, many event records may be created; one is created for each object identified within the frame. When processing has been completed, the event records and the video frame are sent to the device output interfaces. With each video frame that is sent, the exact date and time that was set within the event records created by processing that frame may be attached to the video frame (using appropriate means) to allow synchronization between the event records and video frames. Each video frame may be sent to the analog video output via the output device interface 550. In addition, each frame may be compressed using the configured video compression algorithm and sent to the digital output. Also, each event record created when procesing the frame may be formatted according to the configured protocol and sent to the digital output via the output device interface 550.

Position and orientation information may need to be calibrated, depending on the actual components used in the construction of the device. If this is necessary, it is done according to the specifications of the component manufacturers using external position information sources, map coordinates, compasses, and whatever other external devices and manual procedures are necessary to provide the needed calibration information. The computer program may contain noise and error evaluation logic to determine when and if any accumulated errors are occurring; when found, compensation logic may reset, reconfigure, or adjust automatically to ensure accurate output.

FIG. 7 illustrates an environmentally aware sensor system for surveillance 700 that comprises a video sensor 715. The video sensor 715 provides video signals that correspond to a field-of-view of an AUS. The system also has a computer processor 720 and a position information input 745 for receiving position signals indicative of the location of the system with respect to a real world coordinate system. An orientation information input 750 receives orientation signals that are indicative of the orientation of the video sensor relative to a real world coordinate system. Program modules are employed by the system and are executed by the processor 720.

The program modules include a video processing module 705a for detecting motion of a region within a field-of-view of the sensor 715; a tracking module 705b for determining a path of motion of an object within the region of the field-of-view of the sensor 515. A behavioral awareness module 705c is implemented to identify predetermined behaviors of objects that are identified in the region within the field-of-view of the sensor 515. Additionally, an environmental awareness module 705d is employed by the system, wherein the environmental awareness module 705d is responsive to predetermined information that relates to characteristics of the video sensor 515, the position signals and the orientation signals.

The environmental awareness module 705d also is responsive to outputs from the video processing module 705a, the tracking module 705b for computing geometric equations and mapping algorithms in addition to providing video frame output and event record output indicative of predetermined detected conditions to an external utilization system. The system further comprises a time signal input for receiving time signals. The fore mentioned program modules are responsive to the time signals for associating a time with the event record output. The program modules also include an object detection module 705e, and an objection classification module 705f that are responsive to the video signals for detecting an object having predetermined characteristics and for providing an object identifier corresponding to a detected object for utilization by other program modules within the sensor system 715. Further, an image stabilization module 705g is implemented for stabilizing the raw output of the video sensor prior to provision as event information.

FIG. 8 illustrates an embodiment of the present invention that comprises an environmentally aware sensor 800 for a surveillance system. The sensor comprises a video sensor 815, the video sensor 815 providing video signals that are detected in the field-of-view of an AUS. A position information source 845 receiver obtains position information in regard to the sensor, and further, an IMU 850 detects the relative position of the video sensor 715. A camera lens 810 is situated on the video sensor, wherein the camera lens 810 has predetermined optical characteristics.

A clock receiver 820 provides time signals in regard to events detected by the video sensor 815. The sensor also comprises a computer processor 835 that is responsive to signals from the video sensor 815, position signals from the position information source receiver 845, position signals from the IMU 850, time signals from the clock receiver 820 and predetermined other characteristics of the sensor. The computer processor 835 also executes predetermined program modules, the program modules being stored within a memory in addition to having the capability to utilize in conjunction with their specific programming requirements the video sensor signals, position information source position signals, IMU position signals and said time signals in addition to other signal inputs.

The processor 835 operative to execute the stored program modules for the functions of detecting motion within a field-of-view of the video sensor, detecting an object based on the acquired video signals, tracking the motion of a detected object, classifying the object according to a predetermined classification scheme. Additionally, the program modules provide event record data comprising object identification data, object tracking data, object position information, time information and video signals associated with a detected objected. Also, a data communications network interface 860 is employed to provide the event record data to an external utilization system.

FIG. 11 illustrates a method for determining the characteristics of an object detected by a surveillance sensor in an area under surveillance that relates to embodiments of the present invention. Initially, at step 1105 the position, orientation and time index of signals is determined and provided by a surveillance sensor. The position, orientation and time index signals are based upon position, orientation, and time input signals that are gathered relative to a predetermined real world spatial and temporal coordinate system. At step 1110 the surveillance sensor detects an object within an AUS. Lastly, at step 1115 event information is provided to an external utilization system, the event information comprises signals from the surveillance sensor, information corresponding to attributes of the detected object in addition to position information associated with the detected object relative to the predetermined real world spatial and temporal coordinate system.

FIG. 12 illustrates yet another method for providing object information from a sensor in a security monitoring environment for utilization by a security monitoring system that relates to embodiments of the present invention. At step 1205 the method places an environmentally aware sensor in an area under surveillance, the sensor having a range of detection and predetermined sensor characteristics and inputs for receipt of position information from a position information source and orientation information from an orientation information source. At step 1210, the environmentally aware sensor self determines the location of the environmentally aware sensor relative to a 3D real world coordinate system based on the position information and the orientation information.

Next, at step 1215, the 3D coordinates of the area within the range of detection of the environmentally aware sensor are determined based on the predetermined sensor characteristics and the determined location and orientation of the sensor. An object within the range of detection of the environmentally aware sensor is detected at step 1220 and at step 1225 the 3D location of the detected object within the range of detection of the environmentally aware sensor is determined. Lastly, at step 1230 the location of the detected object is provided in addition to identifying information relating to the detected object and a data feed from the EA sensor to the external security monitoring system.

The functions of capturing and communicating sensor state information enable embodiments of environmentally aware sensors to be configured in varying forms. As described herein, the sensing capabilities of the present invention are collocated, joined, and built into a single unit. However, this may not be cost effective for certain embodiments. Alternative embodiments that separate or distribute the various sensing components across multiple computers in a distributed system are possible and may be the most effective for a given implementation scenario.

Alternative embodiments of the present invention can be defined such that any environmentally aware sensor component or set of components that provide(s) input to the environmental awareness module can be implemented separately from that module. This allows for existing commercially available components to implement the environmentally aware sensor in a logical form but not a physical form.

Therefore, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An environmentally aware surveillance device, comprising; An environmentally aware surveillance device, comprising;
a surveillance sensor for detecting objects within an area under surveillance;
environmental awareness means operative to determine the position and orientation of the surveillance sensor relative to a real world spatial coordinate system, for associating a position of an object detected by the surveillance sensor with respect to the real world spatial coordinate system, and for generating an event information output corresponding to the detected object and associated position; and
an output port for providing said event information output to an external utilization system.

2. The surveillance device of claim 1, further comprising time means for associating time information of the object detected by the surveillance sensor, and wherein the event information output includes the time information.

3. The surveillance device of claim 2, wherein said time means comprises a clock receiver for receiving time information from an external source.

4. The surveillance device of claim 3, wherein said clock receiver is operative to obtain time information from an atomic time clock.

5. The surveillance device of claim 4, wherein said clock receiver is operative to obtain time information from a global positioning system.

6. The surveillance device of claim 1, wherein the self-determination of position and orientation is derived from information provided by a global positioning system satellite and from known physical attributes of the sensor.

7. The surveillance device of claim 6, wherein the known physical attributes of the sensor include position, elevation, angle of view, lens focal length, and inertial measurement.

8. The surveillance device of claim 1, wherein the event information comprises a data feed from the sensor and a mapping of the location of the detected object to a three-dimensional spatial model of the area under surveillance.

9. The surveillance device of claim 1, wherein the sensor device is a video camera.

10. The surveillance device of claim 9, further comprising image stabilization means for stabilizing the raw output of the video camera prior to provision as event information.

11. The surveillance device of claim 9, further comprising image enhancement means for enhancing the output of the video camera prior to provision as event information.

12. The surveillance device of claim 1, wherein the sensor device is operative to convert two-dimensional coordinates of a data array of the sensor into a three-dimensional real world coordinate, and wherein the event information includes the three-dimensional real world coordinate of the detected object.

13. The surveillance device of claim 1, wherein the detected object within the area under surveillance comprises an object that is moving within the field-of-view of the sensor.

14. The surveillance device of claim 13, wherein the object is of a predetermined type of a plurality of object types, each type having an object type identifier, and further comprising the steps of identifying the type of object, assigning an object identifier to the object, and providing the object identifier and the object type identifier as a part of the event information.

15. The surveillance device of claim 1, wherein the surveillance sensor is selected from the group of: video camera, audio listening device, sonar, radar, seismic, laser, infrared, thermal, and electrical field.

16. A self-contained stand alone environmentally aware surveillance device operative to provide event information as an output, comprising:
a surveillance sensor for provided surveillance signals detected in an area under surveillance;
a time circuit for determining the time of surveillance signals provided by the surveillance sensor;
a position information source for self-detecting the physical location of the surveillance device in a geographic coordinate system;
a sensor orientation information source operative for detecting the relative position of the surveillance sensor with respect to the geographic coordinate system;
a processor responsive to signals from the surveillance sensor, the clock receiver, the position sensor, and the sensor orientation unit for processing such signals and generating event information corresponding to a detected event detected by the sensor, said event information comprising attributes of objects identified by said surveillance signals, time information, and position and orientation information with respect to a detected event in the area under surveillance; and
an output port for providing said event information for external utilization.

17. The surveillance device of claim 16, wherein the processor is operative to determine a three-dimensional location of a detected event in the AUS derived by processing signals from the sensor and mapping such event data to a three-dimensional data model of the area under surveillance and providing the three-dimensional location information as a part of the event information in a three-dimensional coordinate system.

18. The surveillance device of claim 16, wherein the time circuit comprises an atomic clock.

19. The surveillance device of claim 16, wherein the position information source comprises a global positioning system satellite receiver.

20. The surveillance device of claim 16, wherein the processor is further responsive to predetermined information about the known physical attributes of the sensor including position, elevation, angle of view, lens focal length, and inertial measurement, in connection with generating the event information.

21. The surveillance device of claim 16, wherein the event information comprises a data feed from the surveillance sensor and a mapping of the location of the detected event to a three-dimensional spatial model of the area under surveillance.

22. The surveillance device of claim 16, wherein the surveillance sensor is a video camera.

23. The surveillance device of claim 22, further comprising image stabilization means for stabilizing the raw output of the video camera prior to provision as event information.

24. The surveillance device of claim 22, further comprising image enhancement means for enhancing the output of the video camera prior to provision as event information.

25. The surveillance device of claim 16, wherein the surveillance sensor is operative to convert two-dimensional coordinates of a data array representing the output of the surveillance sensor into three-dimensional real world coordinates, and wherein the event information includes the three-dimensional real world coordinate of the detected event.

26. The surveillance device of claim 16, wherein the detected event of the area under surveillance comprises an object that is detected as moving within the range of detection of the sensor.

27. The surveillance device of claim 26, wherein the object is of a predetermined type of a plurality of object types, each type having an object type identifier, and wherein the processor is further operative for executing program steps for identifying the type of object, assigning an object identifier to the object, and providing the object identifier and the object type identifier as a part of the event information.

28. The surveillance device of claim 16, wherein the surveillance sensor is selected from the group of: video camera, audio listening device, sonar, radar, seismic, laser, infrared, thermal, and electrical field.

29. An environmentally aware video camera, comprising;
a video camera for monitoring an area under surveillance and for providing video output signals;
environmental awareness means operative to self determine the position, orientation, and time of the video camera relative to a real world spatial and temporal coordinate system, and for generating event information corresponding to the position and time of the AUS by the video camera; and
an output port for providing said event information and said video signals to an external utilization system.

30. The environmentally aware video camera of claim 29, further comprising time means for obtaining time information and for associating time information with an object detected by the video camera, and wherein the event information includes the time information.

31. The environmentally aware video camera of claim 30, wherein the time means comprises an atomic clock.

32. The environmentally aware video camera of claim 29, wherein the self-determination of position and orientation is derived from information provided by a global positioning system receiver and from known physical attributes of the video camera.

33. The environmentally aware video camera of claim 29, wherein the known physical attributes of the video camera include position, elevation, angle of view, lens focal length, and orientation measurements.

34. The environmentally aware video camera of claim 29, wherein the event information comprises a data feed from the video camera and a mapping of the location of an object within the field-of-view of the video camera to a three-dimensional spatial model of the area under surveillance.

35. The environmentally aware video camera of claim 34, further comprising image stabilization means for stabilizing the raw output of the video camera prior to provision as event information.

36. The environmentally aware video camera of claim 34, further comprising image enhancement means for enhancing the output of the video camera prior to provision as event information.

37. The environmentally aware video camera of claim 29, further comprising a processor operative for executing program steps for converting two-dimensional coordinates of event data from the video camera into three-dimensional real world coordinates, and wherein the event information include the three-dimensional real world coordinates of a detected object in the AUS within the field of view of the video camera in the AUS.

38. The environmentally aware video camera of claim 37 wherein the detected object comprises an object that is moving within the field-of-view of the video camera.

39. The environmentally aware video camera of claim 38, wherein the object is of a predetermined type of a plurality of object types, each of the object types having an object type identifier, and wherein the process is further operative for executing program steps for identifying the type of object, assigning an object identifier to the object, and providing the object identifier and the object type identifier as a part of the event information.

40. A method for determining the characteristics of an object detected by a surveillance sensor in an area under surveillance, comprising the steps of:
self determining the position, orientation, and time index of signals provided by the surveillance sensor, based on position, orientation, and time inputs or signals, relative to a predetermined real world spatial and temporal coordinate system;
detecting an object within the AUS by the surveillance sensor; and
providing event information to an external utilization system, the event information comprising signals from the surveillance sensor, information corresponding to attributes of the detected object, and position information associated with the detected object relative to the predetermined real world spatial and temporal coordinate system.

41. The method of claim 40, wherein the time index is time information provided by a time input, and further comprising the step of associating the time information with the object detected by the surveillance sensor, and wherein the event information includes the time information.

42. The method of claim 41, wherein the time input is provided by an atomic clock.

43. The method of claim 40, wherein the self-determination of position and orientation is derived from information provided by a global positioning system satellite and from known physical attributes of the sensor.

44. The method of claim 43, wherein the known physical attributes of the sensor include position, elevation, angle of view, lens focal length, and orientation.

45. The method of claim 40, wherein the event information comprises a data feed from the sensor and a mapping of the location of the detected object to a three-dimensional spatial model of the area under surveillance.

46. The method of claim 40, wherein the surveillance sensor is a video camera.

47. The method of claim 46, further comprising image stabilization means for stabilizing the raw output of the video camera prior to provision as event information.

48. The method of claim 46, further comprising image enhancement means for enhancing the output of the video camera prior to provision as event information.

49. The method of claim 40, further comprising the steps of converting two-dimensional coordinates of a data array of the sensor into three-dimensional real world coordinates, and wherein the event information includes the three-dimensional real world coordinates of the detected object.

50. The method of claim 40, wherein the detected object in the AUS comprises an object that is moving within the field-of-view of the sensor.

51. The method of claim 50, wherein the object is of a predetermined type of a plurality of object types, each type having an object type identifier, and further comprising the steps of identifying the type of object, assigning an object identifier to the object, and providing the object identifier and the object type identifier as a part of the event information.

52. The method of claim 40, wherein the surveillance sensor is selected from the group of: video camera, audio listening device, sonar, radar, seismic, laser, infrared, thermal, and electrical field.

53. The method of claim 40, wherein attributes of the detected object include information selected from the group of object position, object size, object type, object speed, object direction of travel.

54. An environmentally aware sensor for a surveillance system, comprising:
a video sensor for providing video signals detected in the field-of-view of an area under surveillance;
a global positioning system receiver for obtaining position information from global positioning satellites relative to a geographic coordinate system;
an inertial measurement unit for detecting the relative orientation of the video sensor;
a camera lens on the video sensor having predetermined optical characteristics;
a clock receiver for providing time signals;
a computer processor responsive to signals from the video sensor, position signals from the global positioning system receiver, position signals from the inertial measurement unit, time signals from the clock receiver, and predetermined other characteristics of the sensor, for executing predetermined program modules;
a memory for storing predetermined program modules for execution on the processor utilizing said video sensor signals, said global positioning system position signals, said inertial measurement unit position signals, and said time signals;
said processor is operative to compute stored program modules for detecting motion within the field-of-view of the video sensor, detecting an object based on the video signals, tracking the motion of a detected object, classifying the object according to a predetermined classification scheme, and for providing event record data comprising object identification data, object tracking data, object position information, time information, and video signals associated with a detected objected; and
a data communications network interface for providing said event record data to an external utilization system.

55. The environmentally aware sensor of claim 54, wherein said event record data comprises at least information pertaining to the time, date and location of an event.

56. An environmentally aware sensor system for surveillance, comprising:
a video sensor for providing video signals corresponding a field-of-view of an area under surveillance;
a computer processor;
a position information input for receiving position signals indicative of the location of the system with respect to a real world coordinate system;
an orientation information input for receiving orientation signals indicative of the orientation of the video sensor relative to the real world coordinate system;
program modules operative to execute on said computer processor including:
a video processing module for detecting motion of a region within the field-of-view of the sensor;
a tracking module for determining a path of motion of said region within the field-of-view of the sensor;
a behavioral awareness module for identifying predetermined behaviors of said region within the field-of-view of the sensor;
an environmental awareness module responsive to predetermined information relating to characteristics of the video sensor, said position signals, and said orientation signals, and outputs from said video processing module, said tracking module, and said behavioral awareness module, for computing geometric equations and mapping algorithms, and for providing video frame output and event record output indicative of predetermined detected conditions to an external utilization system.

57. The sensor system of claim 56, further comprising a time signal input for receiving time signals, and wherein said program modules are responsive to said time signals for associating a time with said event record output.

58. The sensor system of claim 56, wherein the program modules include an object detection module responsive to said video signals for detecting an object having predetermined characteristics and for providing an object identifier corresponding to a detected object for utilization by other program modules within the sensor system.

59. The sensor system of claim 58, wherein the tracking module is operative to determine a path of motion of a detected object detected by said object detection module.

60. The sensor system of claim 58, wherein the program modules include an object classification module responsive to said video signals or said object identifier for identifying an object having predetermined characteristics and for providing an object type identifier corresponding to a detected type of object for utilization by other program modules within the sensor system.

61. The sensor system of claim 58, wherein the behavioral awareness module is operative for identifying predetermined behaviors of a detected and tracked object based on information provided by the object detection module and the tracking module.

62. The sensor system of claim 56, wherein the program modules include an image stabilization module responsive to said video signals for stabilizing an image provided as an output by the sensor system.

63. The sensor system of claim 56, wherein the characteristics of the video sensor include characteristics of the lens associated with the video sensor.

64. The sensor system of claim 56, wherein the event record output provided by the environmental awareness module includes information for mapping (associating) the two-dimensional location of said detected region to a three dimensional location within a real world coordinate system.

65. A method for providing object information from a sensor in a security monitoring environment for utilization by a security monitoring system, comprising these steps of:
placing an environmentally aware sensor in an area under surveillance, the sensor having a range of detection and predetermined sensor characteristics, and inputs for receipt of position information from a position information source and orientation information from an orientation information source;
at the environmentally aware sensor, self determining the location of the sensor relative to a three-dimensional real world coordinate system based on the position information and the orientation information;
determining the three-dimensional coordinates of points within the area within the range of detection of the EA sensor based on the predetermined sensor characteristics and the determined location of the sensor;
detecting an object within the range of detection of the environmentally aware sensor;
determining the three-dimensional location of the detected object within the range of detection of the environmentally aware sensor; and
providing the location of the detected object, identifying information relating to the detected object, and a data feed from the environmentally aware sensor to the external security monitoring system.

66. The method of claim 65, wherein the EA sensor is a video camera.

67. The method of claim 66, wherein the range of detection is the field-of-view of the video camera.

68. The method of claim 66, wherein the data feed from the environmentally aware sensor is a video feed.

69. The method of claim 66, wherein the predetermined sensor characteristics include optical characteristics of a lens on the video camera, and information about the mounting height of the video camera.

70. The method of claim 66, further comprising the step of applying image processing algorithm to the data feed from the video camera so as to identify an object within the range of detection of the video camera as being of a predetermined type of object, assign an object identifier to a detected object, and provide object type information as a part of the identifying information about the detected object.

71. The method of claim 65, further comprising the step of providing geographic information system database information to the environmentally aware sensor for utilization in determining the three-dimensional location of the environmentally aware sensor.

72. The method of claim 65, wherein the orientation information source is an inertial measurement unit coupled to the environmentally aware sensor that detects the movements of the sensor so as to determine the limits of the range of detection of the sensor relative to the determined position of the sensor.
